(19) United States
(12) Patent Application Publication
(10) Pub. No.: US 2026/0346524 A1
(43) Pub. Date: Nov. 5, 2026

(54) METHOD FOR PREPARING MOLDED FLOORBOARD

(71) Applicant: JIANGSU BBL HOME TECHNOLOGY CO., LTD., Changzhou (CN)

(72) Inventors: Yanhui LI, Changzhou (CN); Hongkai XU, Changzhou (CN)

(21) Appl. No.: 19/702,986

(22) Filed: Jun. 9, 2026

(30) Foreign Application Priority Data
Mar. 20, 2026 (CN) 202610344814.X

(51) Int. Cl. B29C 48/00; B29C 48/285; B29C 48/91; B29K 27/06; B29L 9/00; B29L 31/00

(52) U.S. Cl. CPC B29C 48/0021; B29C 48/0022; B29C 48/0023; B29C 48/022; B29C 48/287; B29C 48/91; B29K 2023/06; B29K 2027/06; B29L 2009/00; B29L 2031/732

(57) ABSTRACT

A method for preparing a molded floorboard, which is performed through the following steps. A modified chlorinated polyethylene material is added to raw materials to prepare a substrate panel including a first surface and a second surface. The substrate panel is cut into a semi-finished panel, with a machining allowance of 12-20 mm at peripheral edges relative to a finished product. The peripheral edges of the semi-finished panel are subjected to inclined cutting at an angle of 60-80° via a cutting tool to form a machining notch. Two heating devices are respectively arranged above and below a conveying path to perform radiation heating on the first and second surfaces. After softened, the processing edge within the heating zone is deformed by pressing to cover a machining side of the machining notch, so as to form a rounded edge, thereby obtaining a finished product.

### CROSS-REFERENCE TO RELATED APPLICATIONS

This application claims the benefit of priority from Chinese Patent Application No. 202610344814.X, filed on Mar. 20, 2026. The content of the aforementioned application, including any intervening amendments thereto, is incorporated herein by reference in its entirety.

### TECHNICAL FIELD

This application relates to flooring manufacturing, and more particularly to a method for preparing a molded floorboard.

### BACKGROUND

With the continuous growth of economy and the acceleration of urbanization, there is an increasing demand for the aesthetics and practicality of the living environment. As an important component of home decoration, the texture and performance of flooring have drawn much attention. By means of the high-tech fabrication process, the molded floorboard exhibits similar appearance and tactile feel to the solid wood flooring while also possessing the excellent physical properties of laminate flooring, such as wear resistance and deformation resistance. In this regard, the molded floorboard perfectly satisfies the consumers' need for appearance and practicality.

Furthermore, the continuous rise in the furnished housing deliveries has greatly promote the market demand for standardized and easy-to-install flooring products. Due to the excellent product properties, the molded floorboard is considered as an ideal alternative.

However, the molded floorboard is limited by high production costs and product prices during the practical production and supply, which are primarily caused by low yield rate and complex process design. Currently, there are three main technical problems in this field.

(1) Sawing after Whole-Board Molding

In the conventional methods, the entire sheet is molded first by using large equipment, followed by precise sawing and grooving. The major drawback of this process is that deviations frequently occur during the sawing stage, resulting in a scrap rate exceeding 25%, which significantly increases the overall production cost.

(2) Molding after Small-Angle Cutting

In this method, after the small-angle cutting, the panel requires an additional ultraviolet (UV) paint coating step in the subsequent processing, which not only adds direct costs but also reduces the overall efficiency of the production line.

(3) Direct Thermal Molding after Sawing

This method involves directly heating the edges after sawing, which makes it difficult to balance the heating power. If the power is too high, thermal deformation or even carbonization and discoloration may occur to the board. If the power is too low, the board will not be softened sufficiently, thereby failing to achieve the desired molding effect and causing cracking on the back surface of the board.

Therefore, there is an urgent need to provide a molded floorboard manufacturing process with reduced production costs, improved material utilization, simplified operation and enhanced product stability.

### SUMMARY

Regarding the drawbacks in the existing technology, the present disclosure provides a method for preparing a molded floorboard.

A method for preparing a molded floorboard, comprising:
(S1) mixing substrate raw materials according to a preset weight ratio, wherein the substrate raw materials comprise a polyvinyl chloride resin and a modified chlorinated polyethylene material; extruding or spreading the substrate raw materials to form a substrate layer; and
successively laminating a decorative layer and a wear-resistant layer on a surface of the substrate layer followed by hot-pressing lamination to obtain a substrate panel, wherein a surface on a side of the substrate panel close to the wear-resistant layer is defined as a first surface, and a surface of the substrate panel opposite to the first surface is defined as a second surface;
(S2) cutting the substrate panel into a semi-finished panel, with a machining allowance of 12-20 mm on peripheral edges of the semi-finished panel relative to dimensions of a finished product;
(S3) performing inclined cutting on the peripheral edges of the semi-finished panel via a cutting tool to form a machining notch, wherein the machining notch has a machining side surface extending from an edge of the first surface along a thickness direction of the substrate layer; an inclined-cut angle of 60-80° is formed between the machining side surface and the first surface; an intersection between the machining side surface and the first surface is defined as a processing edge; and a vertical projection of the processing edge on the second surface is defined as a to-be-heated point;
(S4) arranging a first heating device above a conveying path of the semi-finished panel, and arranging a second heating device below the conveying path of the semi-finished panel; and performing thermal radiation heating on the first surface via the first heating device, and performing thermal radiation heating on the second surface via the second heating device to obtain a preheated panel, wherein the first heating device is configured to form a first heating zone on the first surface and heat the first heating zone to 100-150 °C, and the processing edge is located within the first heating zone; and the second heating device is configured to form a second heating zone on the second surface and heat the second heating zone to 80-100 °C, and the to-be-heated point is located within the second heating zone; and
(S5) feeding the preheated panel into a forming channel, wherein the forming channel is internally provided with a forming assembly; physically pressing the processing edge to cause deformation such that the machining side surface is wrapped by the first surface, so as to form an arc-shaped edge and obtain the molded floorboard.

In some embodiments, the modified chlorinated polyethylene material is prepared by mixing chlorinated polyethylene as a matrix material with an impact modifier; a chlorine content of the chlorinated polyethylene is 25-40 wt. %; and the impact modifier is selected from the group consisting of a polyolefin elastomer, an acrylate impact modifier, a methyl methacrylate-butadiene-styrene copolymer and a combination thereof.

In some embodiments, the wear-resistant layer is a transparent calendered polyvinyl chloride film with a thickness of 0.1-0.7 mm.

In some embodiments, the wear-resistant layer contains hard wear-resistant particles of aluminum oxide.

In some embodiments, the decorative layer is a polyvinyl chloride printed film, which comprises a polyvinyl chloride resin substrate and an ink texture layer printed on a surface of the polyvinyl chloride resin substrate.

In some embodiments, in step (S1), the preset weight ratio of the polyvinyl chloride resin to the modified chlorinated polyethylene material is 1:0.08-0.25, indicating that based on 100 parts by weight of the polyvinyl chloride resin, the modified chlorinated polyethylene material is present in an amount of 8-25 parts by weight.

In some embodiments, in a case that the molded floorboard is a wood-plastic composite floorboard, the preset weight ratio of the polyvinyl chloride resin to the modified chlorinated polyethylene material is 1:0.08-0.1; and in a case that the molded floorboard is a stone-plastic composite floorboard, the preset weight ratio of the polyvinyl chloride resin to the modified chlorinated polyethylene material is 1:0.15-0.25.

In some embodiments, the substrate panel further comprises an ultraviolet paint layer; and the substrate panel successively comprises the ultraviolet paint layer, the wear-resistant layer, the decorative layer and the substrate layer from top to bottom.

In some embodiments, in step (S4), the first heating zone and the second heating zone are each configured as a rectangular strip extending along a conveying direction of the semi-finished panel and having a width of 8-15 mm, preferably, 8-12 mm.

In some embodiments, in step (S4), the first heating device and the second heating device are each a linear focused infrared heating device.

In some embodiments, in step (S4), the first heating zone is perpendicularly opposite to the second heating zone in a thickness direction of the semi-finished panel.

In some embodiments, the modified chlorinated polyethylene material in step (S1) is prepared through steps of:
(S101) mixing the chlorinated polyethylene with the impact modifier at a weight ratio of 1:0.1-0.2 in a mixing device to obtain a first mixture, wherein the impact modifier is selected from the group consisting of a polyolefin elastomer, an acrylate impact modifier, a methyl methacrylate-butadiene-styrene copolymer and a combination thereof;
(S102) adding an antioxidant, a lubricant and a coupling agent into the first mixture followed by mixing under stirring at 100-110 °C to obtain a second mixture;
(S103) feeding the second mixture into an extruder followed by segmented temperature-controlled mixing and extrusion to obtain an extruded material, wherein an extrusion temperature follows a gradient distribution of first rising and then falling along a flow direction of the second mixture, and a highest point of the extrusion temperature is located in a mixing section of the extruder, ranging from 160 °C to 170 °C; and
(S104) subjecting the extruded material to shaping, pelletizing and drying to obtain the modified chlorinated polyethylene material.

In some embodiments, in step (S102), the antioxidant is pentaerythritol tetrakis(3-(3,5-di-tert-butyl-4-hydroxyphenyl)propionate) (e.g., antioxidant 1010); the lubricant is zinc stearate; and the coupling agent is a silane coupling agent.

In some embodiments, in step (S102), based on 100 parts by weight of the chlorinated polyethylene, the antioxidant is 0.3-0.5 part by weight; the lubricant is 0.2-0.4 part by weight; and the silane coupling agent is 0.6-0.8 part by weight.

In some embodiments, in step (S103), a screw speed of the extruder is set at 300-450 r/min.

In some embodiments, the modified chlorinated polyethylene material is prepared through steps of:
(S201) feeding chlorinated polyethylene CPE-135A (having a chlorine content of 35±2 wt. %) and a polyolefin elastomer (POE) at a weight ratio of 100:10-20 into a mixer, followed by mixing under stirring for 2-3 h at 80-90 °C;
(S202) adding 0.4 part by weight of the antioxidant 1010, 0.3 part by weight of the zinc stearate and 0.7 part by weight of the silane coupling agent into the mixer followed by mixing under stirring for 8-15 min at 100-110 °C, so as to obtain a third mixture;
(S203) feeding the third mixture into a dual-screw extruder followed by mixing and extrusion to obtain an extruded strand, wherein a feeding section of the dual-screw extruder is set at 120-140 °C with a screw speed of 300-400 r/min; a plasticizing section of the dual-screw extruder is set at 150-160 °C with a screw speed of 300-400 r/min; a mixing section of the dual-screw extruder is set at 160-170 °C with a screw speed of 350-450 r/min; a homogenizing section of the dual-screw extruder is set at 155-165 °C with a screw speed of 300-350 r/min; and a die head of the dual-screw extruder is set at 155-160 °C; and
(S204) subjecting the extruded strand to shaping, pelletizing and drying to obtain the modified chlorinated polyethylene material.

In some embodiments, the substrate raw materials comprise:
65-100 parts by weight of the polyvinyl chloride resin in a powdered form;
240-300 parts by weight of calcium carbonate powder;
6-10 parts by weight of a calcium-zinc stabilizer;
13-20 parts by weight of the modified chlorinated polyethylene material;
1.2-1.9 parts by weight of a first lubricant (internal lubricant); and
1.2-1.9 parts by weight of a second lubricant (external lubricant).

In some embodiments, the internal lubricant is selected from the group consisting of stearic acid (octadecanol), oxidized polyethylene wax (low molecular weight, internal lubricant type) and a combination thereof.

In some embodiments, the external lubricant is selected from the group consisting of polyethylene wax (PE wax), oxidized polyethylene wax (OPE), paraffin wax and a combination thereof.

In some embodiments, the substrate raw materials further comprise 70-90 parts by weight of a recycled material obtained by crushing polyvinyl chloride sheet scraps.

Compared to the prior art, the present disclosure has the following beneficial effects.

By introducing the modified chlorinated polyethylene containing the POE elastomer, the present disclosure constructs a “multi-phase synergistic network” system with the PVC substrate. It fundamentally resolves the drawbacks of cracking and deformation carbonization during the sawing and molding of floorboard. The system not only significantly improves impact resistance and anti-chipping performance but also substantially widens the temperature range of heating process and reduces thermal shrinkage. Furthermore, the technical solutions of this application can improve yield rates without retrofitting existing equipment, thereby achieving cost reduction and efficiency enhancement.

During processing, the present disclosure reserves a machining allowance of 12-20 mm on the peripheral edges of the semi-finished panel relative to dimensions of the finished product. Additionally, the cutting tool is utilized to perform inclined cutting on the peripheral edges of the semi-finished panel at an angle of 60-80° to form the machining notch, effectively ensuring favorable morphology of the subsequent molded floorboard.

The present disclosure employs double-sided differential heating to precisely fit different softening points of the wear-resistant layer and the substrate layer. A surface temperature of the first heating zone adjacent to the wear-resistant layer is maintained at 100-150 °C, while a surface temperature of the second heating zone adjacent to the substrate layer is controlled at 80-100 °C. This specific temperature range activates chain flexibility of POE elastic micro-domains, eliminating cold-brittle cracking during roller pressing. Simultaneously, it prevents sagging of the panel substrate caused by overheating. The deep synergy between material modification and specific temperature control enables a balance between rigidity and flexibility to the substrate raw materials, achieving high-quality molded wrapping and shaping.

### BRIEF DESCRIPTION OF THE DRAWINGS

FIG. 1 is a schematic diagram of a machining notch according to an embodiment of the present disclosure; and

FIG. 2 partially shows a chamfer according to an embodiment of the present disclosure (at one side).

### DETAILED DESCRIPTION OF EMBODIMENTS

In order to make the objects, technical solutions and advantages more clearly, the present disclosure will be further illustrated in combination with the embodiments. It should be noted that although the following embodiments are described using a stone-plastic composite (SPC) floorboard formulation as an exemplary object, the molding process and method of this disclosure are universal. The molding process and method can be widely applied to the production of various types of polyvinyl chloride (PVC) floorboard, including but not limited to these types, and should not be construed as being limited solely to SPC materials. The embodiments described herein are merely illustrative, and are not intended to limit this disclosure.

The present disclosure provides a polyvinyl chloride (PVC) floorboard, where raw materials of a substrate layer include:
75 parts by weight of polyvinyl chloride resin in a powered form;
250 parts by weight of a filling material (i.e., calcium carbonate powder);
80 parts by weight of a recycled material (i.e., crushed polyvinyl chloride sheet scraps);
7 parts by weight of a stabilizer (i.e., calcium-zinc stabilizer);
15 parts by weight of a modified chlorinated polyethylene material;
1.5 parts by weight of an internal lubricant (i.e., stearic acid); and
1.5 parts by weight of an external lubricant (i.e., polyethylene wax).

The modified chlorinated polyethylene material is prepared through the following steps.

(S1) 100 parts by weight of chlorinated polyethylene CPE-135A having a chlorine content of 37 wt. % and 15 parts by weight of polyolefin elastomer (POE) are fed into a mixer, followed by mixing under stirring for 2.5 h at 85 °C to remove moisture and preliminarily homogenize material.

(S2) 0.4 part by weight of antioxidant 1010, 0.3 part by weight of zinc stearate and 0.7 part by weight of silane coupling agent are added into the mixer, followed by mixing under stirring for 10 min at 105 °C to obtain a first mixture.

(S3) The first mixture is fed into a dual-screw extruder followed by mixing and extrusion to obtain an extruded strand, where a feeding section of the dual-screw extruder is set at 120-140 °C with a screw speed of 300-400 r/min; a plasticizing section of the dual-screw extruder is set at 150-160 °C with a screw speed of 300-400 r/min; a mixing section of the dual-screw extruder is set at 160-170 °C with a screw speed of 350-450 r/min; a homogenizing section of the dual-screw extruder is set at 155-165 °C with a screw speed of 300-350 r/min; and a die head of the dual-screw extruder is set at 155-160 °C.

(S4) The extruded strand is subjected to shaping through cooling water at 20-30 °C and pelletizing via a rotary pelletizer, followed by drying for 1-2 h at 60-70 °C to obtain a modified chlorinated polyethylene material with a moisture content below 0.2%.

The chlorinated polyethylene (CPE) adopted herein has a chlorine content of 25-40 wt. %. Generally, in a case that the chlorine content is less than 25 wt. %, the compatibility between CPE and PVC is poor, leading to delamination. In a case that the chlorine content exceeds 45 wt. %, the CPE becomes difficult to process and such a material tends to become brittle. Consequently, high-chlorine CPE is suitable only for special scenarios such as high-temperature anti-corrosion coatings and is not recommended for conventional floorboard or plastic modification.

Although pure CPE-135A possesses good weather resistance and a certain toughening effect, its impact resistance in low-temperature environments is relatively weak. POE features excellent low-temperature flexibility and extremely high elongation at break. In this application, the CPE-135A and POE are subjected to melting and mixing via the dual-screw extruder under conditions of high temperature and high shear to form a favorable microscopic phase structure. Adding this modified CPE to the substrate raw materials can significantly improve the impact strength and flexibility of the floorboard.

Furthermore, the coupling agent is added during the modification process to effectively improve the interfacial adhesion between the polymer resin (the CPE/POE system) and inorganic fillers. This results in a denser internal structure of the finished floorboard product, making it less prone to delamination or cracking.

The addition of the lubricant during the modification process improves the flowability of the material. Meanwhile, the antioxidant prevents thermal-oxidative aging of the CPE and POE during high-temperature processing and long-term use, thereby extending the service life of the floorboard and preventing yellowing.

Using pre-plasticized and uniformly dispersed modified CPE particles for floorboard production can avoid surface defects such as white spots, gel particles, or areas of uneven performance, greatly enhancing both appearance quality and consistency of physical properties.

This disclosure adopts the modified chlorinated polyethylene employing a CPE/POE mixed network structure, while it does not alter a main chain structure of CPE-135A. Moreover, it forms a denser cross-linked network through the synergistic interaction between the compounded components and the PVC molecular chains. This structure enhances polarity compatibility and thermal stability of the system, providing a solid material foundation for the subsequent high-temperature molding process.

The present disclosure provides a method for preparing the PVC floorboard, in which step (S1) is performed through the following steps.

### (S101) Mixing Process

The raw materials for the substrate layer of the PVC floorboard are weighed according to a formulation ratio and fed into a high-speed mixer for mixing. The mixing is stopped after a temperature of the raw materials rises to 110-120 °C, thereby completing preliminary plasticization and dispersion followed by cooling to 65 °C to obtain a first mixture.

### (S102) Extrusion Molding and Online Lamination

After cooling, the first mixture is transported to a storage bin and then fed into a conical dual-screw extruder via a screw feeding system. The first mixture is subjected to shearing, plasticization and melting in the conical dual-screw extruder, and is extruded through a die to form a continuous sheet. The continuous sheet is subjected to a multi-roll calendar to adjust a thickness thereof. Simultaneously, a wear-resistant layer and a decorative layer are laminated onto the continuous sheet followed by a surface embossing treatment using an embossing roller. Subsequently, the continuous sheet is subjected to an online transverse cutting to obtain a high-toughness large-format PVC original floorboard of a preset length, where a surface of the original floorboard close to the wear-resistant layer is defined as a first surface, and a surface of the original floorboard opposite to the first surface is defined as a second surface.

Step (S2) is performed through the following steps.

### (S201) Fixed-Length Cutting

The original board is subjected to secondary precise cutting, where the original board is cut into a semi-finished panel 2 approximating dimensions of a finished product, with a machining allowance of 15 mm on peripheral edges of the semi-finished panel 2.

### (S202) Conditioning

The semi-finished panel 2 obtained in step (S201) is left to stand indoors at a temperature of 15-40 °C for 10 to 15 days for conditioning.

Step (S3) is performed through the following steps.

After conditioning, the semi-finished panel 2 are conveyed horizontally with the wear-resistant layer facing downward. An inclined cutting with a depth of approximately 1-2 mm is performed on the peripheral edges of the semi-finished panel 2 via a cutting tool to form a machining notch 1.

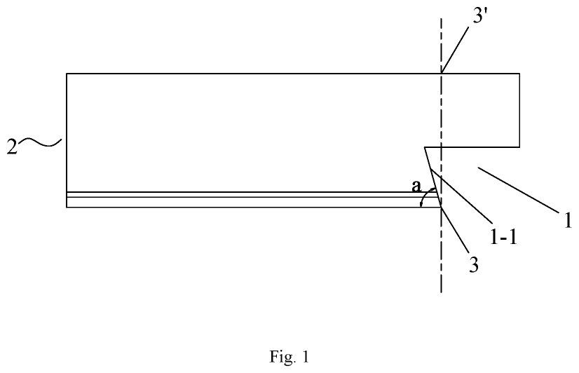

Referring to FIG. 1, the machining notch 1 includes a machining side surface 1-1 extending from an edge of the first surface along a thickness direction of the substrate layer, and an inwardly-recessed part connected to the machining side surface 1-1. An inclined-cut angle a of 60-80° is formed between the machining side surface 1-1 and the first surface. An intersection of the machining side surface 1-1 and the first surface is defined as a processing edge 3. A vertical projection of the processing edge 3 on the second surface is defined as a to-be-heated point 3′. A dotted line running through the first surface and the second surface as shown in FIG. 1 is a vertical center auxiliary line, which are used to indicate that the processing edge 3 and the to-be-heated point 3′ are in a vertical and direct alignment position.

### (S4) Dual-Side Differential Linear Heating

A first linear focused infrared heating device is arranged above a conveying path of the semi-finished panel 2, and a second linear focused infrared heating device is arranged below the conveying path of the semi-finished panel 2. Thermal radiation heating is performed starting from the processing edge 3 through the first linear focused infrared heating device, and thermal radiation heating is performed starting from the to-be-heated point 3′ through the second linear focused infrared heating device. Focused light areas formed by the first and second linear focused infrared heating devices on the surface of the semi-finished panel 2 are each configured as a rectangular strip-shaped area extending along a conveying direction of the semi-finished panel 2, which are respectively defined as a first heating zone and a second heating zone and each have a width of 10 mm.

By adjusting a conveying speed of the semi-finished panel 2 and powers of the first and second linear focused infrared heating devices, the first heating zone located on the first surface is heated to 100-150 °C, facilitating the softening and plasticity of the sheet material. The second heating zone located on the second surface is heated to 80-100 °C, promoting the heat to penetration into the core of the sheet material, allowing the sheet material to be plasticized and preventing cracking.

Online infrared temperature sensors are utilized to monitor real-time temperatures of the first and second heating zones on the first surface and the second surface, respectively.

In this case, the first and second linear focused infrared heating devices are respectively provided on two sides of the semi-finished panel 2 to maintain a core temperature of processing area of the PVC sheet material at approximately 80 °C. Such a temperature range not only satisfies the softening conditions required for the high-elastic transition of the PVC sheet material but also effectively prevents hard brittle fracture of the sheet material during roller pressing.

Step (S5) is performed through the following steps.

### (S501) Roller-Pressing Molding

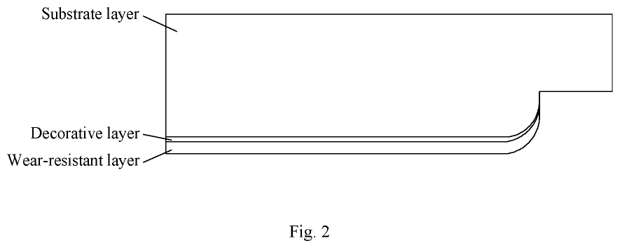

A preheated sheet material obtained in step (S4) is fed into a forming channel. The forming channel includes an upper wheel set and a lower wheel set, where the upper wheel set is configured to contact a non-molded panel surface to provide stable support for a molded panel surface, while the lower wheel set is configured to feature an arc design. After softened, the processing edge 3 is physically pressed through the forming channel to cause deformation such that the machining side surface 1-1 is wrapped by the first surface, so as to form an arc-shaped edge (as shown in FIG. 2). A curvature radius of the arc-shaped edge is determined by a contact surface of the lower wheel set and can be customized according to customer requirements.

### S502 Cooling Shaping and Precise Lock Processing

A formed sheet material obtained from step (S501) is rapidly cooled and shaped by air cooling, thereby solidifying the chamfer profile to obtain a shaped sheet material. The peripheral edges of the shaped sheet material are subjected to machining to form tongues and grooves and complete a locking groove cutting process, so as to yield the finished product of the molded floorboard.

To investigate and determine an optimal inclined-cut angle in step (S3), this application established three experiment groups while keeping other process parameters consistent. Each experimental group was executed according to steps (S1-S5), with the only difference being the use of different inclined-cut angles in step (S3). Ultimately, the chamfer profiles of three sheet materials obtained from the three experiment groups were compared as shown in Table 1.

TABLE 1
Comparison of three groups of sheet materials in chamfer profile

| | Inclined-cut angle | | |
|---|---|---|---|
| | 57° | 75° | 83° |
| Molded | A side of the wear- | Good | The second surface close to |
| floorboard | resistant layer was | | the substrate layer has |
| shape | separated. | | cracks. |

As shown in the above results, when the cutting tool chamfered at an angle of 750 (within the range of 60-80°), the resulting sheet material exhibited a desirable chamfer profile.

With the optimal inclined-cut angle of 75° determined for step (S3), the embodiments 1-3 and the comparative examples 1-2 were performed according to the aforementioned method to prepare floorboard samples with different formulations of the substrate layer (the specific formulations were each shown in Table 2, unit: parts by weight).

TABLE 2
Composition of substrate layer

| | | | | Compar- | Compar- |
|---|---|---|---|---|---|
| | Embodi- | Embodi- | Embodi- | ative | ative |
| | ment | ment | ment | exam- | exam- |
| | 1 | 2 | 3 | ple 1 | ple 2 |
| PVC resin | 75 | 90 | 60 | 75 | 90 |
| powder | | | | | |
| Calcium | 250 | 295 | 250 | 250 | 295 |
| carbonate | | | | | |
| powder | | | | | |
| Common | 0 | 0 | 0 | 10 | 15 |
| CPE | | | | | |
| Modified | 15 | 20 | 8 | 0 | 0 |
| CPE | | | | | |
| Recycled | 80 | 80 | 60 | 80 | 80 |
| material | | | | | |
| Stabilizer | 7 | 10 | 5 | 6.8 | 10 |
| PE wax | 1.5 | 1.7 | 1.2 | 1.5 | 1.6 |
| Stearic acid | 1.5 | 1.7 | 1.2 | 1.2 | 1.4 |

This application evaluated the impact of the substrate layer formulation on the final performance of the molded floorboard by conducting mechanical property and durability tests on floorboard samples prepared with different substrate layer formulations in the embodiments 1-3 and comparative examples 1-2. The test results were detailed in Table 3. It was noted that, when conducting mechanical property sampling, to ensure the representativeness and accuracy of the test data, all test specimens were taken from the central area of the sheet material, avoiding the areas adjacent to the edge chamfers.

TABLE 3
Mechanical performance test results

| | Test | Embodiment | Embodiment | Embodiment | Comparative | Comparative |
|---|---|---|---|---|---|---|
| Test item | standard | 1 | 2 | 3 | example 1 | example 2 |
| Static bending | GB/ | 27.4 | 28.0 | 23.5 | 24.6 | 25.3 |
| strength | T17657 | | | | | |
| transverse | | | | | | |
| (MPa) | | | | | | |
| Static bending | GB/ | 26.5 | 27.1 | 24.4 | 24.4 | 25.8 |
| strength | T17657 | | | | | |
| longitudinal | | | | | | |
| (MPa) | | | | | | |
| Modulus of | GB/ | 8700 | 8597 | 7650 | 7550 | 7850 |
| elasticity | T17657 | | | | | |
| transverse | | | | | | |
| (MPa) | | | | | | |
| Modulus of | GB/ | 7521 | 7700 | 6874 | 6990 | 7010 |
| elasticity | T17657 | | | | | |
| longitudinal | | | | | | |
| (MPa) | | | | | | |
| Caster chair test | GB/ | 8000 | 8500 | 6500 | 6100 | 6400 |
| (rpm) | T4085 | | | | | |

It was noted that, the passing standard for this castor chair test was 8,000 rpm. After the test was completed, no defects were permitted on the floorboard surface or inside its structure, and no cracks were allowed in the internal substrate materials after disassembly.

Based on the analysis of the above test results, with the resin ratio maintained constant, Embodiments 1-2 (using modified chlorinated polyethylene, i.e., modified CPE) exhibited significant performance advantages over Comparative examples 1-2 (using ordinary CPE). These advantages included effectively enhanced static bending strength and elastic modulus, as well as improved performance in the castor chair test. This fully demonstrated that the modified CPE in this substrate layer formulation significantly enhanced the toughness of the product.

To evaluate the adaptability and tolerance of different substrate layer formulations to the molding process of this application, the sheet materials were subjected to roller-pressing treatment according to the aforementioned preset process conditions. Specifically, the sheet materials were fed into the forming channel after heating and softening. After heating and softening, the processing edge 3 was physically pressed to cause deformation such that the machining side surface 1-1 was wrapped by the first surface to form the arc-shaped edge as the standard. After the roller-pressing treatment, the structural integrity of the second surface close to the substrate layer was observed, and the results were detailed in Table 4.

TABLE 4
Structural integrity of the second surface

| | Embodiment | Embodiment | Embodiment | Comparative | Comparative |
|---|---|---|---|---|---|
| | 1 | 2 | 3 | example 1 | example 2 |
| Second | No | No | The second | The second | The second |
| surface of the | significant | significant | surface had | surface had | surface had |
| sheet | abnormality. | abnormality. | cracks. | cracks. | cracks. |
| material near | | | | | |
| the substrate | | | | | |
| layer | | | | | |

The improved substrate layer formulations adopted in Embodiments 1-2 maintained structural stability on the second surface with no significant abnormalities after undergoing the roller-pressing treatment of this application. This indicated that this formulation system possessed excellent hot-pressing stability and stress resistance, fully meeting the requirements of the molding process of this application.

Compared to Embodiments 1-2, the substrate layer formulation of Embodiment 3 contained a lower proportion of resin, a higher proportion of calcium carbonate powder, and a reduced amount of modified material.

Under the same molding conditions, the second surface of the sheet material obtained in Embodiment 3 as well as Comparative Examples 1-2 all had cracks. This proved that their substrate layer formulation systems lacked sufficient stability and cannot withstand the stress generated during the roller-pressing treatment, resulting in damage to the structural integrity of the sheet material.

To evaluate the impact of the heating temperature on the substrate layer on the performance of the finished product during the dual-side infrared differential temperature softening process in step (S4) and determine the optimal temperature range, the substrate layer formulation and the entire processing method described in Embodiment 1 were served as a control benchmark. By adjusting the conveying speed of the semi-finished panel 2 and the powers of the first and second linear focused infrared heating devices, the temperature of the first heating zone on the first surface was maintained at 100-150 °C, while a series of different temperatures for the second heating zone on the second surface were set as comparative examples for verification. The results were shown in Table 5.

TABLE 5
Effect of heating temperature on state of the second surface

| | Temperature of the | State of the second |
|---|---|---|
| | second heating zone | surface |
| Embodiment 1 | No heating | obvious cracks |
| | 80-100 °C | no obvious abnormalities |
| | 60-80 °C | slight cracks |
| | 100-120 °C | no obvious cracks, |
| | | presenting a sagging |
| | | state |

Using Embodiment 1 as a performance reference benchmark, it was ultimately determined that under the premise of maintaining the temperature of the first heating zone on the first surface close to the wear-resistant layer at 100-150 °C, the second heating zone on the second surface close to the substrate layer was heated to 80-100 °C, which was the most reasonable range for completing the dual-side infrared differential temperature softening and subsequent roller pressing processes of the present disclosure.

Described above are merely preferred embodiments of the present disclosure, and are not intended to limit this disclosure. Although the present disclosure has been disclosed in detail above with reference to the preferred embodiments, those skilled in the art can still make various variations, modifications and replacements thereto. It should be understood that any variations, modifications and replacements made without departing from the spirit and scope of the present disclosure shall still fall within the scope of the present disclosure defined by the appended claims.

What is claimed is:

1. A method for preparing a molded floorboard, comprising:
(S1) mixing substrate raw materials according to a preset weight ratio, wherein the substrate raw materials comprise a polyvinyl chloride resin and a modified chlorinated polyethylene material; extruding or spreading the substrate raw materials to form a substrate layer; and
successively laminating a decorative layer and a wear-resistant layer on a surface of the substrate layer followed by hot-pressing lamination to obtain a substate panel, wherein a surface on a side of the substrate panel close to the wear-resistant layer is defined as a first surface, and a surface of the substrate panel opposite to the first surface is defined as a second surface;
(S2) cutting the substrate panel into a semi-finished panel, with a machining allowance of 12-20 mm on peripheral edges of the semi-finished panel relative to dimensions of a finished product;
(S3) performing inclined cutting on the peripheral edges of the semi-finished panel via a cutting tool to form a machining notch, wherein the machining notch has a machining side surface extending from an edge of the first surface along a thickness direction of the substrate layer; an inclined-cut angle of 60-80° is formed between the machining side surface and the first surface; an intersection between the machining side surface and the first surface is defined as a processing edge; and a vertical projection of the processing edge on the second surface is defined as a to-be-heated point;
(S4) arranging a first heating device above a conveying path of the semi-finished panel, and arranging a second heating device below the conveying path of the semi-finished panel; and performing thermal radiation heating on the first surface via the first heating device, and performing thermal radiation heating on the second surface via the second heating device to obtain a preheated panel, wherein the first heating device is configured to form a first heating zone on the first surface and heat the first heating zone to 100-150 °C, the processing edge is located within the first heating zone; and the second heating device is configured to form a second heating zone on the second surface and heat the second heating zone to 80-100 °C, and the to-be-heated point is located within the second heating zone; and
(S5) feeding the preheated panel into a forming channel, wherein the forming channel is internally provided with a forming assembly; physically pressing the processing edge to cause deformation such that the machining side surface is wrapped by the first surface, so as to form an arc-shaped edge and obtain the molded floorboard.

2. The method of claim 1, wherein the modified chlorinated polyethylene material is prepared by mixing chlorinated polyethylene as a matrix material with an impact modifier; a chlorine content of the chlorinated polyethylene is 25-40 wt. %; and the impact modifier is selected from the group consisting of a polyolefin elastomer, an acrylate impact modifier, a methyl methacrylate-butadiene-styrene copolymer and a combination thereof.

3. The method of claim 1, wherein the wear-resistant layer is a transparent calendered polyvinyl chloride film; and the decorative layer is a polyvinyl chloride printed film, which comprises a polyvinyl chloride resin substrate and an ink texture layer printed on a surface of the polyvinyl chloride resin substrate.

4. The method of claim 1, wherein in step (S1), the preset weight ratio of the polyvinyl chloride resin to the modified chlorinated polyethylene material is 1:0.08-0.25.

5. The method of claim 1, wherein in step (S4), the first heating zone and the second heating zone are each configured as a rectangular strip extending along a conveying direction of the semi-finished panel and having a width of 8-15 mm;
the first heating device and the second heating device are each a linear focused infrared heating device; or
the first heating zone is perpendicularly opposite to the second heating zone in a thickness direction of the semi-finished panel.

6. The method of claim 2, wherein the modified chlorinated polyethylene material in step (S1) is prepared through steps of:
(S101) mixing the chlorinated polyethylene with the impact modifier at a weight ratio of 1:0.1-0.2 in a mixing device to obtain a first mixture;
(S102) adding an antioxidant, a lubricant and a coupling agent into the first mixture followed by mixing under stirring at 100-110 °C to obtain a second mixture;
(S103) feeding the second mixture into an extruder followed by segmented temperature-controlled mixing and extrusion to obtain an extruded material, wherein an extrusion temperature follows a gradient distribution of first rising and then falling along a flow direction of the second mixture, and a highest point of the extrusion temperature is located in a mixing section of the extruder, ranging from 160 °C to 170 °C; and
(S104) subjecting the extruded material to shaping, pelletizing and drying to obtain the modified chlorinated polyethylene material.

7. The method of claim 6, wherein in step (S102), the antioxidant is pentaerythritol tetrakis(β-(3,5-di-tert-butyl-4-hydroxyphenyl)propionate); the lubricant is zinc stearate; and the coupling agent is a silane coupling agent.

8. The method of claim 6, wherein in step (S103), a screw speed of the extruder is set at 300-450 r/min.

9. The method of claim 1, wherein the substrate raw materials comprise:
65-100 parts by weight of the polyvinyl chloride resin in a powdered form;
240-300 parts by weight of calcium carbonate powder;
6-10 parts by weight of a calcium-zinc stabilizer;
13-20 parts by weight of the modified chlorinated polyethylene material;
1.2-1.9 parts by weight of a first lubricant; and
1.2-1.9 parts by weight of a second lubricant.

10. The method of claim 9, wherein the substrate raw materials further comprise 70-90 parts by weight of a recycled material obtained by crushing polyvinyl chloride sheet scraps.
